(19) United States
(12) Patent Application Publication
(10) Pub. No.: US 2009/0319308 A1
(43) Pub. Date: Dec. 24, 2009

(54) EQUIPMENT RETROFITTING PROJECT METHOD

(76) Inventors: Shane S. Guiltner, Cochrane (CA); Gornik Andrey, Calgary (CA)

Correspondence Address: LAW OFFICE OF MARK BROWN, LLC, 4700 BELLEVIEW SUITE 210, KANSAS CITY, MO, 64112, US

(21) Appl. No.: 12/141,661

(22) Filed: Jun. 18, 2008

(51) Int. Cl. G06Q 10/00

(52) U.S. Cl. 705/7; 705/1

(57) ABSTRACT

An equipment retrofitting project method includes the steps of conducting sales, project management (PM)/design, production and field service phases. The PM/design phase includes the steps of providing a coordinate measuring machine (CMM) and measuring spatial and dimensional coordinates of natural gas compressor station components with the CMM at the compressor station location. The coordinates are related to a reference at the compressor station location. Output is provided from the CMM in the form of part coordinate system (PCS) data comprising the spatial and dimensional data associated with the components and a 3-D model is created from the PCS data. In the production phase new and/or refurbished components are produced utilizing the PCS data at a location remote from the equipment. In the field service phase the new or refurbished components are installed in the equipment.

### BACKGROUND OF THE INVENTION

1. Field of the Invention

The present invention relates generally to equipment retrofitting projects, and in particular to a method for retrofitting components of a remote facility, such as a natural gas compressor station.

2. Description of the Related Art

Various types of operating equipment require periodic service, including updating to meet current application demands. For example, natural gas compressor stations are part of a distribution system and are located at intervals along gas pipelines. Natural gas pipelines include “mainlines,” which extend across vast geographic areas and carry large quantities of natural gas at relatively high pressures from the producing fields to the major population centers. Compressors used for transporting natural gas include conventional reciprocating compressors, rotary screw compressors and turbine engines. Various other equipment components include intake side scrubbers and fillers, unloaders, suction/discharge valve assemblies, interstage coolers (for multistage compression) and post-compression coolers on the discharge side. The natural gas is routed through the compressor station components via suitable piping networks.

Significant amounts of energy are consumed in transporting natural gas. Such energy can be provided by the natural gas as a fuel source for the compressors, or they can be driven by electrical power. Either way, compressor operating efficiencies are very important for the economic viability of pipeline systems. Such operating efficiency considerations have created a strong demand for compressor station updating and retrofitting services, particularly since investments in upgrading existing facilities and improving operating efficiencies tend to be relatively cost-effective and provide paybacks. Moreover, many compressor stations have been in operation for decades whereby revamping equipment to optimize operating efficiencies is periodically needed to take advantage of current state-of-the-art engineering and technology.

Common services associated with upgrading compressor stations include retrofitting, reconfiguring and revamping equipment. The compressors themselves are sometimes restaged and recylindered. Optimizing operating efficiency normally involves specialized consultants, who employ sophisticated computer modeling and engineering design software. Typical retrofit and equipment upgrade projects can involve significant fabrication, machining and construction services, which tend to be highly customized and project-specific. Portions of the machining, fabrication and manufacturing work can be automated using available computer aided manufacturing (CAM) systems, which can receive design inputs from computer aided drafting and design (CADD) systems.

The compressor stations are often located in relatively remote locations chosen for pipeline operating efficiencies and other considerations, including environmental. Geographic remoteness can contribute significantly to the costs of engineering projects, particularly those requiring sophisticated design, fabrication, construction and installation phases. Mobilizing and transporting personnel, components and equipment tends to involve expenses proportional to the remoteness and distances associated with projects. In other words, greater distances between consultants, component production facilities and jobsites often correlate to greater travel and transportation expenses, as well as time delays. These challenges are not limited to natural gas compressor station projects and are commonly encountered in various other types of projects where resources are geographically distant from the jobsites. Another, related cost consideration involves relocating workers and other resources on-site for extended periods of time. Such resources are often needed on-site due to the project-specific nature of the materials and components, which have to be field-adapted to accommodate close tolerances and specific field conditions. Scheduling is another important aspect of projects such as compressor stations, for which downtime can be disruptive of operations and expensive. Time out-of-service must generally be minimized.

Previous compressor station projects tended to involve the considerations discussed above. Successfully retrofitting compressor stations commonly required significant on-site activity involving design and fabrication and the presence of construction personnel and equipment. An equipment retrofitting system would preferably address some or all of these considerations. For example, minimizing field activity in favor of shop or fabrication facility production is generally preferred because field operations tend to be inherently more expensive and less precise. Manufacturing, machining and fabricating components in a controlled environment, such as an off-site facility, tends to produce better results at a lower cost than comparable operations conducted on remote jobsites, which may be exposed to ambient conditions, including inclement weather, and other deficiencies. For example, field welding operations are commonly employed to obtain precise fits of components and interconnecting piping. However, if the precise locations of different connections in three-dimensional space could be determined in advance, much of the field welding activity could be replaced by pre-construction fabrication off-site.

Heretofore there has not been available a method for retrofitting equipment with the advantages and features of the present invention.

### BRIEF DESCRIPTION OF THE INVENTION

In the practice of an aspect of the present invention, a method is provided for retrofitting equipment and includes sales, project management (PM)/design, production and field service phases. The existing system and conditions are modeled electronically in a three-dimensional modeling system using either relative or Earth-based coordinates (XYZ). Such three-dimensional electronic models are used for designing, machining, fabricating and manufacturing the systems being retrofitted, including various components and equipment. The relatively high accuracy of the software used for modeling the physical aspects of the projects enables remote prefabrication and pre-assembly procedures, which tend to minimize on-site activities by consultants, fabricators and others.

### BRIEF DESCRIPTION OF THE DRAWINGS

The drawings constitute a part of this specification and include exemplary embodiments of the present invention and illustrate various objects and features thereof.

FIG. 1 is a generalized flowchart showing an aspect of the equipment retrofitting method of the present invention.

FIG. 2 is a flowchart showing a sales phase.

FIG. 3 is a flowchart showing a continuation of the sales phase.

FIG. 4 is a flowchart showing a continuation of the sales phase and a project management/design phase.

FIG. 5 is a flowchart showing a continuation of the project management/design phase.

FIG. 6 is a flowchart showing a continuation of the project management/design phase and production and field service phases.

FIG. 7 is a flowchart showing continuations of the production and field service phases.

FIG. 8 is a perspective view of components of a natural gas compressor station, which can be modeled from coordinate measuring machine (CMM) data imported to a parametric computer aided drafting and design (CADD) modeling application.

FIG. 9 is a perspective view of a component of the natural gas compressor station, which can be manufactured from a production drawing based on the CADD model.

FIG. 10 is a field generated inspection report form based on CMM-derived data using a part coordinate system (PCS).

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, base, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning.

### II. Equipment Retrofitting Method 2

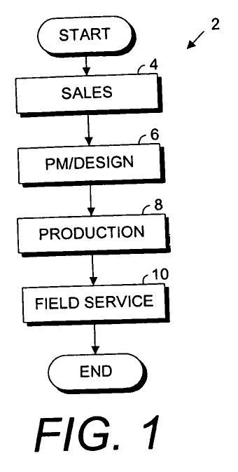

Referring to the drawings in more detail, the reference numeral 2 generally designates an equipment retrofitting method embodying an aspect of the present invention. As shown in FIG. 1, the method 2 generally involves a sales phase 4, a project management (PM)/design phase 6, a production phase 8 and a field service phase 10.

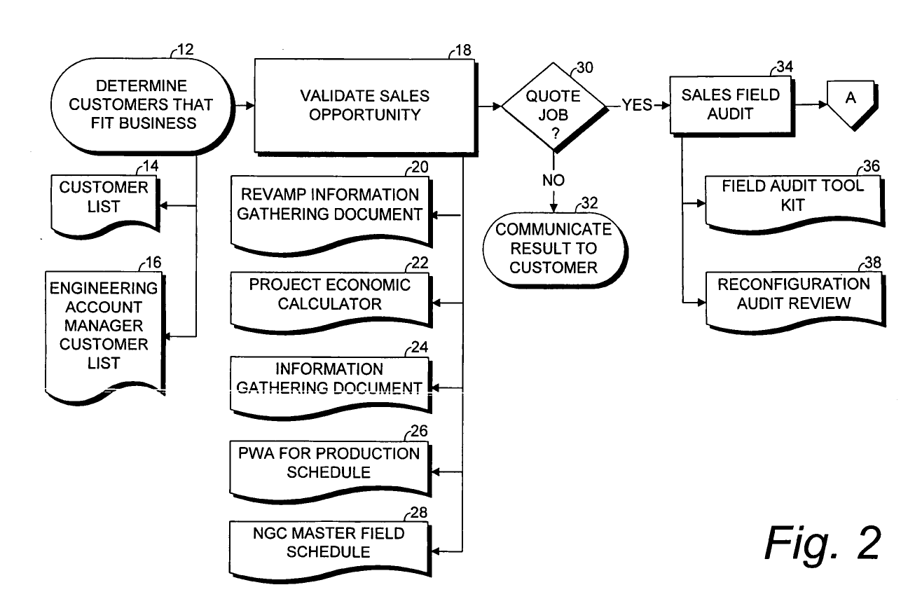

As shown in FIG. 2, the sales phase commences with a determination at step 12 of customers that are suitable for the entity (consultant, provider and/or vendor) operating the method 2, utilizing resources such as, for example, a general customer list at 14 and a specific resource, such as an engineering account manager customer list at step 16. Sales opportunities are validated at 18, leading to steps comprising revamping information gathering document at 20, producing project economic calculator at 22, information gathering document at 24, project web access (PWA) production schedule at 26 and master field schedule at 28. A negative decision at Quote Job? decision box 30 leads to communicating the result to the customer at 32. An affirmative decision leads to a field sales audit at 34 utilizing a field audit tool kit at 36 and leading to reconfiguring an audit review at 38.

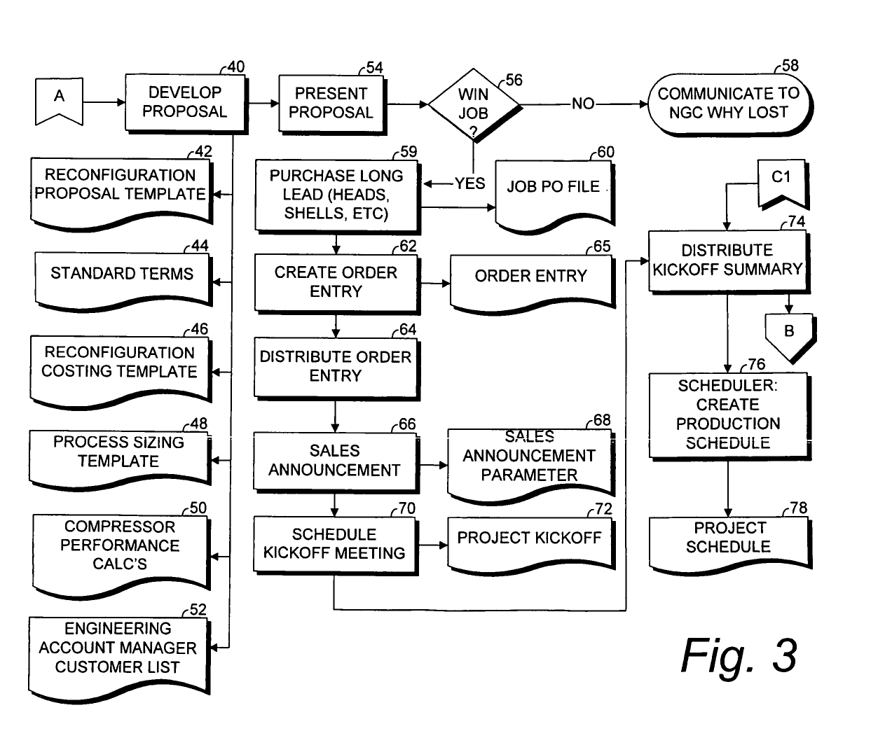

FIG. 3 continues from connecting arrow A in FIG. 2 and includes portions of the sales and PM/design phases 4, 6. A proposal is developed at 40, the proposal template reconfigured at 42, standard terms are provided at 44, the costing template is reconfigured at 46, the process sizing template is provided at 48, the compressor performance calculations are performed at 50 and engineering account manager reports are provided at 52. The proposal is presented at 54, leading to a Win Job? decision box at 56, from which a negative decision leads to the step of communicating why the job was lost at 58. An affirmative decision at 56 leads to purchasing long lead items at 58 (e.g., heads, shells, etc. for a compressor station retrofit project).

A job purchase order (PO) file is created at 60. An order entry is created at 62, distributed at 64 and entered at 65. A sales announcement is made at 66, the parameters of which can be defined at 68. The entity can employ appropriate communications, accolades and acknowledgments for “winning” a sales order, which can motivate, reward, congratulate and inspire employees. A kickoff meeting is scheduled at step 70 and conducted at 72. A kickoff summary is distributed at 74, a production schedule is created at 76 and the project schedule is created at 78.

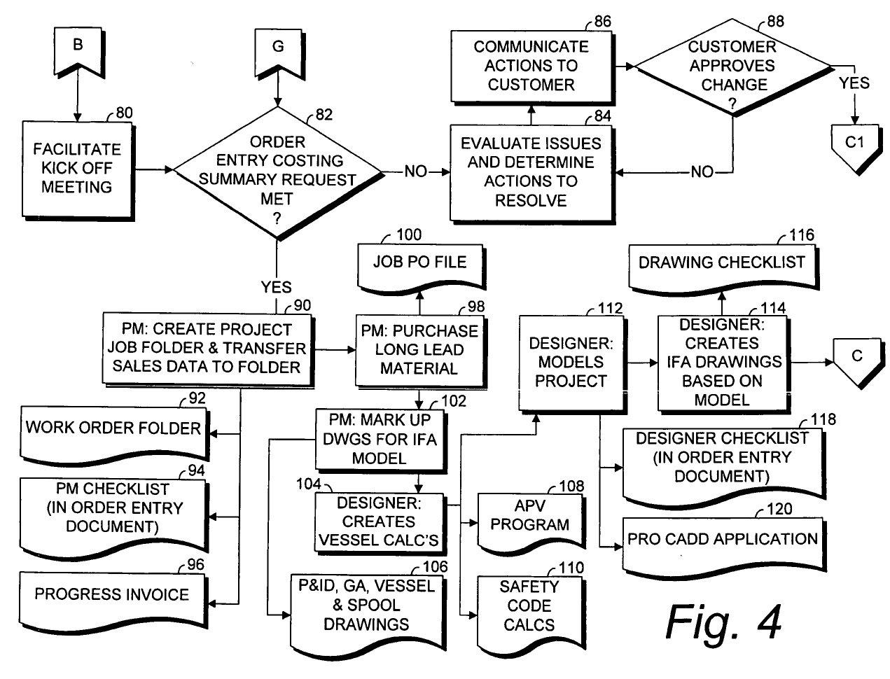

Connecting arrow B in FIG. 3 leads to facilitating the kickoff meeting at 80 in FIG. 4. An Order Entry Costing Summary Request Met? decision box 82 (negative decision) leads to evaluating issues and determining actions to resolve at 84, communicating actions to customer at 86 and Customer Approves Change? decision box 88, from which a negative decision loops back to evaluating issues at 84. An affirmative decision from 88 loops back to distributing kickoff summary at 74 (C1 reference to FIG. 3). An affirmative decision at 82 leads to the project manager (PM) creating a project job folder and transferring sales data thereto at 90, from which a work order folder is created at 92, a PM checklist is created at 94 and a progress invoice is created at 96. Long lead material is purchased at 98 and entered into the job PO file at 100. The PM marks the drawings for an issued for approval (IFA) model at 102 whereat the drawings and documents are sent to the customer, the designer creates vessel calculations at 104 and process and instrumentation diagram (P & ID), general arrangement (GA), vessel and spool drawings at 106. An advanced pressure vessel (APV) program is created at 108 and safety code compliance calculations (e.g., state or provincial pressure vessel codes, which may be based on American Society of Mechanical Engineers (ASME)) standards) are performed at 110. The project is modeled at 112, based on which the designer creates IFA drawings at 114 and a drawing checklist is created at 116. A designer checklist (in order entry document) is created at 118 and a computer-aided drafting and design (CADD) application occurs at 120.

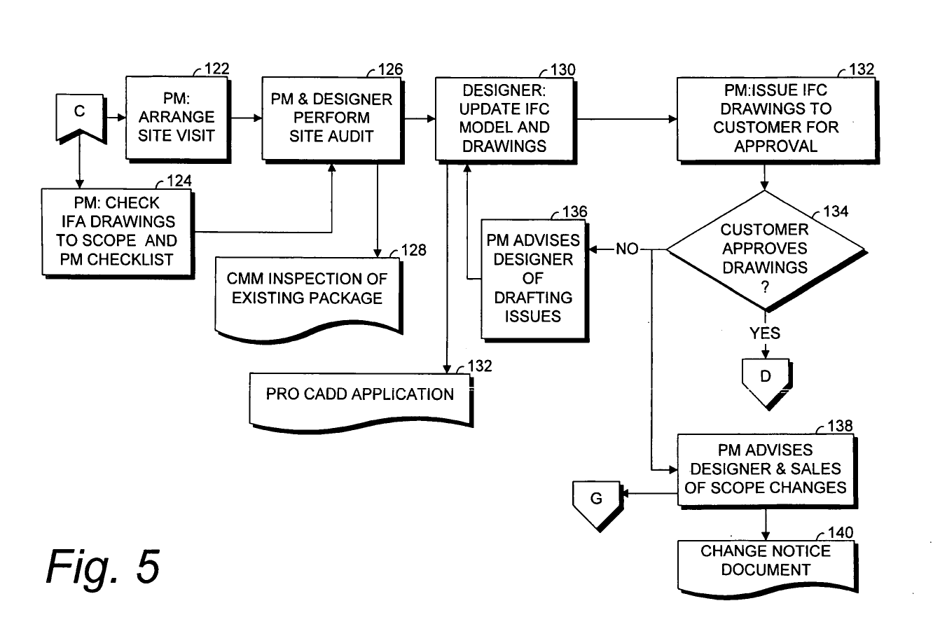

From 114 the method proceeds to FIG. 5 in the PM/design phase 6 via C. The PM arranges a site visit at 122 and checks the IFA drawings at 124. The PM and the designer perform a site audit at 126 and coordinate measuring machine (CMM) inspection of the existing package occurs at 128. The designer updates the issued for construction (IFC) model and drawings at 130 with the CADD application at 132. The PM issues IFC drawings to the customer for approval at 132, leading to Customer Approves Drawings? decision box 134, with a negative decision leading to the PM advising the designer of drafting issues at 136 and the PM advising the designer and sales of scope changes at 138 and providing a change notice document at 140. Step 138 loops back to step 82 in FIG. 4 via connecting arrow G.

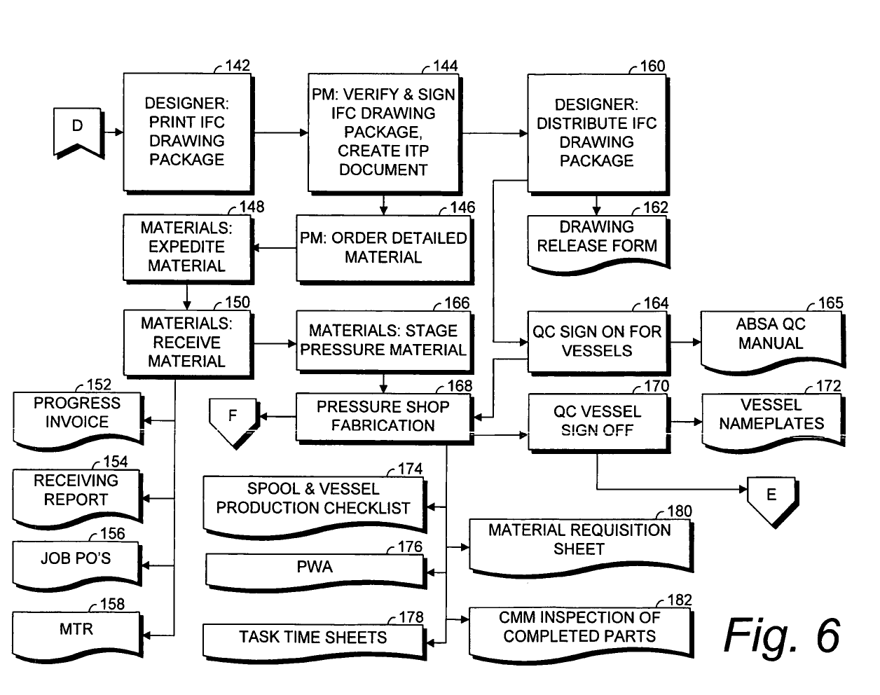

An affirmative decision at 134 leads to FIG. 6 via connecting arrow D and to the step of the designer printing the IFC drawings package at 142. The PM verifies and signs the IFC drawings package and creates an industrial test plan (ITP) document at 144 and orders detailed material at 146, which can be expedited at 148 with the materials being received at 150. A progress invoice is created at 152, a receiving report is created at 154, job POs are created at 156 and a material traceability report (MTR) is created at 158. The designer distributes the IFC drawing package at 160 and the drawing release form at 162. Quality-control (QC) signs for the vessels (e.g., in a compressor station project) at 164, leading to an ABSA QC manual step at 165.

From 150 a pressure material step occurs at 166 leading to pressure shop fabrication at 168, which leads to QC vessel sign off at 170 and leads to a vessel nameplate step at 172. Step 168 also leads to a spool and vessel production checklist at 174, PWA at 176 and task timesheets at 178. A material requisition step occurs at 180 and CMM inspection of completed parts occurs at 182.

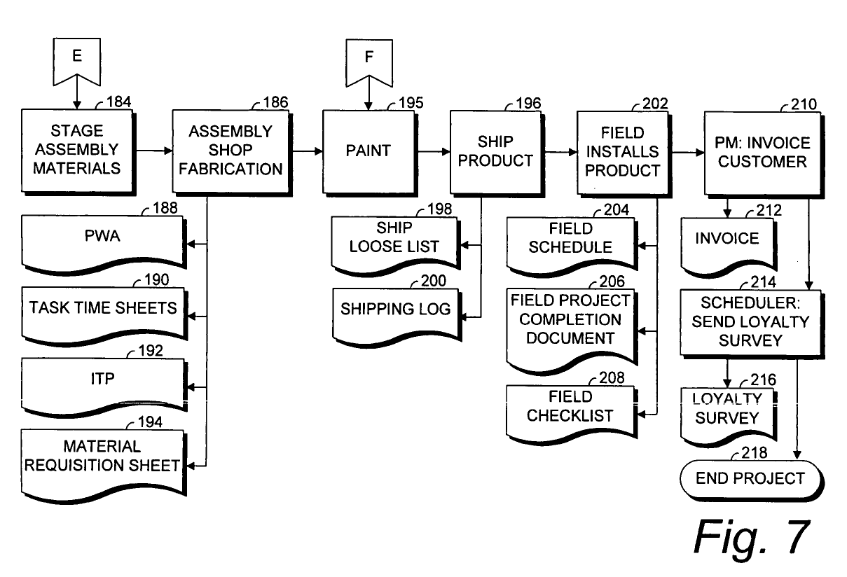

Step 170 leads to staging assembly material at 184 (FIG. 7) via connecting arrow E, which leads to assembly shop fabrication at 186, PWA at 188, task timesheets at 190, ITP at 192 and material requisition sheet at 193. Paint step 194 occurs after either 168 (via connecting arrow F) or 186 and product is shipped at 196. A ship loose list is created at 198 and a shipping log is created at 200. From step 196 the method also proceeds to product field installation at 202, field scheduling at 204, a field project completion document at 206 and a field checklist at 208. Also from step 202 the PM invoices the customer at 210, creating an invoice at 212, the scheduler sends a loyalty survey at 214 followed by a loyalty survey step at 216 and the project ends at 218.

### III. Compressor Station Retrofit Project Application

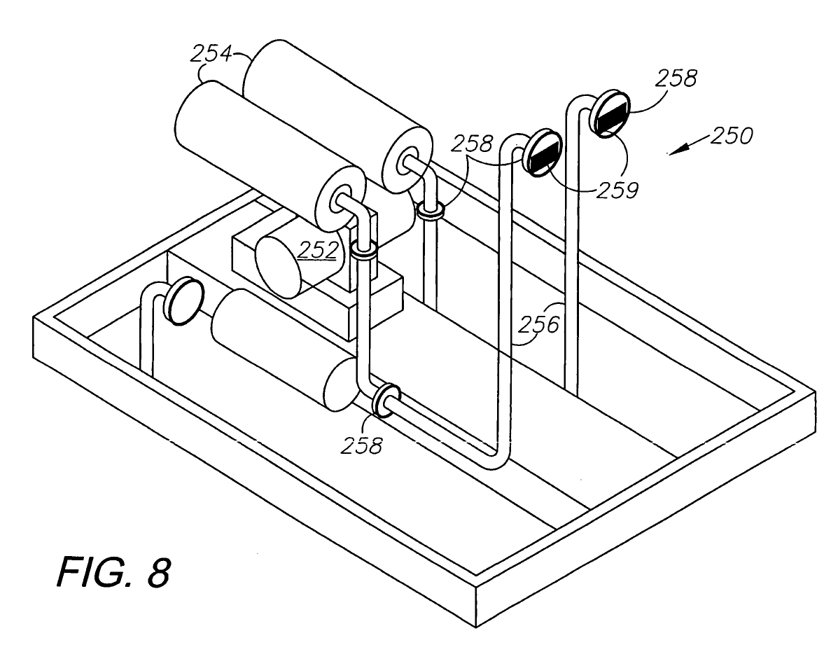

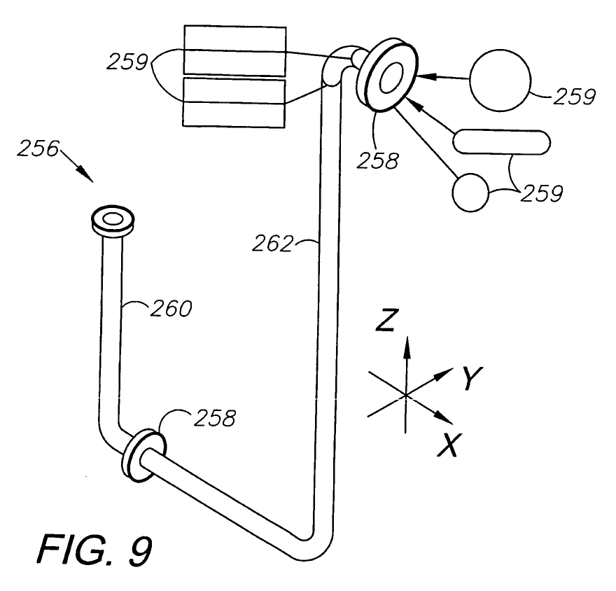

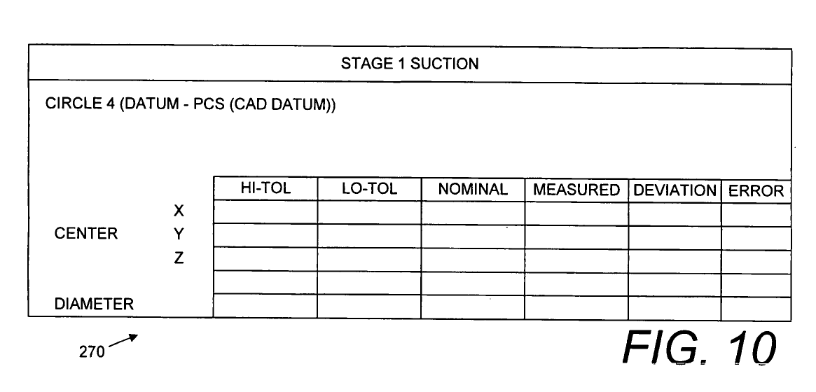

In an exemplary application of the equipment retrofitting project method embodying an aspect of the present invention, a compressor station is retrofit. FIG. 8 shows components of a typical compressor station, which is generally designated by the reference numeral 250 and includes a reciprocating compressor 252 connected to intercoolers 254, which discharge to process spools 256. The process spools 256 include multiple connecting flanges 258, which connect the spools 256 to adjacent upstream and downstream components, and interconnect spool sections 260, 262. The precise locations of the connecting flanges 258 are determined by the CMM to a desired degree of accuracy with respect to three axes (X, Y, Z). Such 3-D PCS data is transferred from the field inspection equipment (including the CMM) to a suitable CADD system for creating production drawings. The production drawings can show the process spool 256 isolated from the other components, as shown in FIG. 9. Alternatively, the components can be modeled in three dimensions entirely electronically, with digital data providing the input to a computer aided manufacturing (CAM) system. The data associated with the process spool 256 can be referenced or included in data annotations 259, which are keyed to different features of the component, such as the flanges 258 of the process spool 256. Such data can include nominal and measured XYZ positional information based on the PCS, tolerances, measured positional data, deviation, etc. and can be recorded on field survey reports, such as a form 270 shown in FIG. 10.

It will be appreciated that the functionality of the entire process 2 is facilitated and enhanced by the CMM providing a relatively precise, 3-D model in electronic (i.e. digital) format for accurately designing, modeling, manufacturing and fabricating new and replacement components remote from the jobsite. By locating such components, including their interconnections, in the 3-D (XYZ) part coordinate system (PCS) based on a chosen reference point, fieldwork traditionally performed at the jobsite can be significantly reduced and the actual construction and installation (field service) phase of the project expedited because fit and interchangeability aspects have been worked out offsite. The CMM modeling procedure can incorporate a wide variety of modeling, design and manufacturing functions relating to physical attributes associated with the existing equipment and the reconditioned and/or new components being installed. For example, physical dimensions in three dimensions (XYZ) can be provided for components standalone and in relation to other components on the project. Thus, the CMM-based model avoids problems with misfitting and interfering components, which problems are addressed and solved according to the present method prior to the commencement of the installation and construction phases on-site. Other functionalities of the method include bill-of-material generation, QC, procurement, scheduling, testing, construction management and invoicing.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. An equipment component retrofitting project method, which includes the steps of:
conducting a project management/design phase including providing a coordinate measuring machine (CMM);
measuring spatial and dimensional coordinates of an equipment component with said CMM at an on-site location with the equipment;
providing output from said CMM in the form of part coordinate system (PCS) data comprising said spatial and dimensional components;
creating a 3-D model from said PCS data;
conducting a production phase comprising the production of a new or refurbished component utilizing said PCS data;
conducting said production phase at a location remote from the equipment; and
conducting a field service phase comprising installing said new or refurbished component in the equipment.

2. The method according to claim 1, which includes the additional steps of:
including coordinates and dimensions establishing high and low tolerances, nominal dimensions, measured dimensions, deviations and errors in said PCS data.

3. The method according to claim 2, which includes the additional step of:
producing said refurbished or new components with a computer-aided manufacturing (CAM) system.

4. The method according to claim 3, which includes the additional steps of:
reviewing said design for compliance with a building or safety code.

5. The method according to claim 4, which includes the additional steps of:
subjecting said equipment design to an automated performance testing software procedure; and
submitting results of said automated performance testing to appropriate authorities for establishing compliance with said building or safety code.

6. The method according to claim 2, which includes the additional steps of:
modeling said equipment including both new or refurbished components and existing components in a computer-aided drafting and design (CADD) program using said PCS data; and
outputting information from said CADD model to a computer-aided manufacturing (CAM) program.

7. The method according to claim 1, which includes the additional steps of:
inspecting the completed refurbished or new component with the CMM; and
identifying any discrepancies between said design and said refurbished or new components.

8. A method of revamping a natural gas compressor station including a compressor, vessels, spools and other compressor station equipment components, with said compressor station being located along a natural gas pipeline at an on-site project location, which method comprises the steps of:
conducting a sales phase including the steps of providing an engineering account manager, identifying potential customers with natural gas compressor stations, gathering equipment revamping information and calculating project economics;
conducting a project management/design phase including providing a coordinate measuring machine (CMM);
measuring spatial and dimensional coordinates of natural gas compressor station components with said CMM at said compressor station location;
relating said coordinates to a reference at said compressor station location;
providing output from said CMM in the form of part coordinate system (PCS) data comprising said spatial and dimensional components;
creating a 3-D model from said PCS data;
conducting a production phase comprising the production of new and/or refurbished components utilizing said PCS data;
conducting said production phase at a production phase location remote from the compressor station location; and
conducting a field service phase comprising installing said new or refurbished component in the equipment.

9. The method according to claim 8, which includes the additional steps of: developing a proposal including the sub steps of reconfiguring a proposal template, providing standard terms, reconfiguring a costing template, providing a process sizing template and performing compressor performance calculations; and
presenting said proposal to a potential customer.

10. The method according to claim 8, which includes the additional steps of:
creating an issued for approval (IFA) model including vessel calculations, process and instrumentation diagrams (P & ID), general arrangement (GA) drawings and spool drawings;
presenting said IFA model to a customer for approval; and
revising said IFA model as necessary to secure customer approval.

11. The method according to claim 10, which includes the additional steps of:
determining applicable safety and building codes;
conducting pressure vessel calculations with an advanced pressure vessel (APV) program based on said codes; and
documenting with said APV program compliance with said codes.

12. The method according to claim 11, which includes the additional steps of:
performing a site audit using said IFA model;
conducting a CMM inspection of existing equipment;
comparing said IFA model and results of said CMM inspection;
producing an issued for construction (IFC) model and drawings based on said IFA model and said CMM inspection; and
updating said IFC model as necessary for compatibility with said existing equipment.
